(19) United States
(12) Patent Application Publication
(10) Pub. No.: US 2020/0031959 A1
(43) Pub. Date: Jan. 30, 2020

(54) RUBBERY POLYMER EXTRUSION DRYER, METHOD OF DRYING RUBBERY POLYMER, AND METHOD OF PRODUCING RUBBERY POLYMER

(71) Applicant: ZEON CORPORATION, Tokyo (JP)

(72) Inventor: Masao NAKAMURA, Tokyo (JP)

(73) Assignee: ZEON CORPORATION, Tokyo (JP)

(21) Appl. No.: 16/491,427

(22) PCT Filed: Mar. 27, 2018
(86) PCT No.: PCT/JP2018/012282

§ 371 Date: Sep. 5, 2019

(30) Foreign Application Priority Data
Mar. 27, 2017 (JP) 2017-061936

(51) Int. Cl. C08F 6/24; F26B 5/14

(52) U.S. Cl. CPC C08F 6/24; F26B 5/14

(57) ABSTRACT

A rubbery polymer extrusion dryer includes a cylinder; and a die having a plurality of openings at one end of the cylinder, wherein each of the openings includes an opening base and at least one extended opening portion in communication with the opening base, and the extended opening portion has a shape with an opening width expanding in a direction away from the opening base.

### TECHNICAL FIELD

The present invention relates to a rubbery polymer extrusion dryer, a method of drying a rubbery polymer, and a method of producing a rubbery polymer.

### BACKGROUND ART

In a process of producing rubbery polymers, an extrusion dryer is known for use in drying rubbery polymers that are rich in moisture after the polymerization and coagulation processes. The extrusion dryer includes a die having a plurality of openings at one end of a cylinder, and the rubbery polymer loaded into the cylinder is conveyed to a die and extruded from nozzles of the die to an open air. In this process, the moisture contained in the rubbery polymer rapidly evaporates and is released to an open air, and the rubbery polymer is dried.

Japanese Patent. No. 5805304 (Patent Document 1), for example, discloses an expansion extrusion dryer using a cross-shaped or star-shaped die nozzle.

### RELATED-ART DOCUMENT

### Patent Document

[Patent Document 1] Japanese Patent. No. 5805304, FIGS. 1 to 7

### SUMMARY OF THE INVENTION

### Problem to be Solved by the Invention

In a typical related-art extrusion dryer; however, fine powder and small powder (hereinafter referred to as fine powder) are frequently generated during extrusion drying of the rubbery polymer, or moisture remains in a rubbery polymer after extrusion drying, resulting in insufficient drying of the rubbery polymer. The fine powder generated during such a drying operation and moisture remaining in the rubbery polymer cause the rubbery polymer to deteriorate, thereby degrading the quality and productivity of the rubbery polymer. Hence, there is a need for an extrusion dryer that can reduce the generation of fine powder and perform sufficient drying.

It is an object of the present invention to provide a rubbery polymer extrusion dryer, which is capable of reducing the generation of fine powder and capable of performing sufficient drying.

### Means for Solving the Problem

According to one embodiment of the present invention, a rubbery polymer extrusion dryer includes

a cylinder; and

a die having a plurality of openings at one end of the cylinder, wherein

each of the openings includes an opening base and at least one extended opening portion in communication with the opening base, and

the extended opening portion has a shape with an opening width expanding in a direction away from the opening base.

### Advantageous Effects of Invention

According to one embodiment of the present invention, a rubbery polymer extrusion dryer that is capable of reducing the generation of fine powder and capable of performing sufficient drying may be provided.

### BRIEF DESCRIPTION OF THE DRAWINGS

FIG. 1 is a view illustrating an extrusion dryer according to an embodiment of the present invention;

FIG. 2A is a front view of a die with a cutter attached in an extrusion dryer according to the present embodiment;

FIG. 2B is another view of FIG. 2A from which illustration of a cutter is omitted;

FIG. 3 is a diagram illustrating a shape of a die nozzle (first embodiment) in an extrusion dryer according to the present embodiment;

FIG. 4 is a diagram illustrating a shape of a die nozzle (second embodiment) in an extrusion dryer according to the present embodiment;

FIG. 5 is a diagram illustrating a shape of a die nozzle (third embodiment) in an extrusion dryer according to the present embodiment;

FIG. 6 is a diagram illustrating a shape of a die nozzle (fourth embodiment) in an extrusion dryer according to the present embodiment;

FIG. 7 is a diagram illustrating a shape of a die nozzle (fifth embodiment) in an extrusion dryer according to the present embodiment;

FIG. 8 is a diagram illustrating a shape of a die nozzle (sixth embodiment) in an extrusion dryer according to the present embodiment;

FIG. 9 is a diagram illustrating a shape (cross-shape) of a die nozzle in a related art extrusion dryer;

FIG. 10 is a diagram illustrating a shape (star-shape) of a die nozzle in a related art extrusion dryer;

FIG. 11 is an enlarged view of a portion of an interior of a liner in an extrusion dryer according to the present embodiment;

FIG. 12 is an expanded view illustrating a portion of a liner in an extrusion dryer according to the present embodiment;

FIG. 13A is a cross-sectional view cut along a 4A-4A line of FIG. 12;

FIG. 13B is a cross-sectional view cut along a 4B-4B line of FIG. 12;

FIG. 14 is a schematic diagram of a screw in an extrusion dryer according to the present embodiment; and

FIG. 15 is a flowchart illustrating an example of a method for producing a rubbery polymer according to the present embodiment.

### DETAILED DESCRIPTION OF THE PREFERRED EMBODIMENTS

The following illustrates embodiments of the present invention with reference to the accompanying drawings. Note that in order to facilitate understanding of a reader, the scale of each member in the drawings may be different from the actual scale. In this embodiment, the description of the common parts in each figure is omitted with the same or corresponding reference numerals.

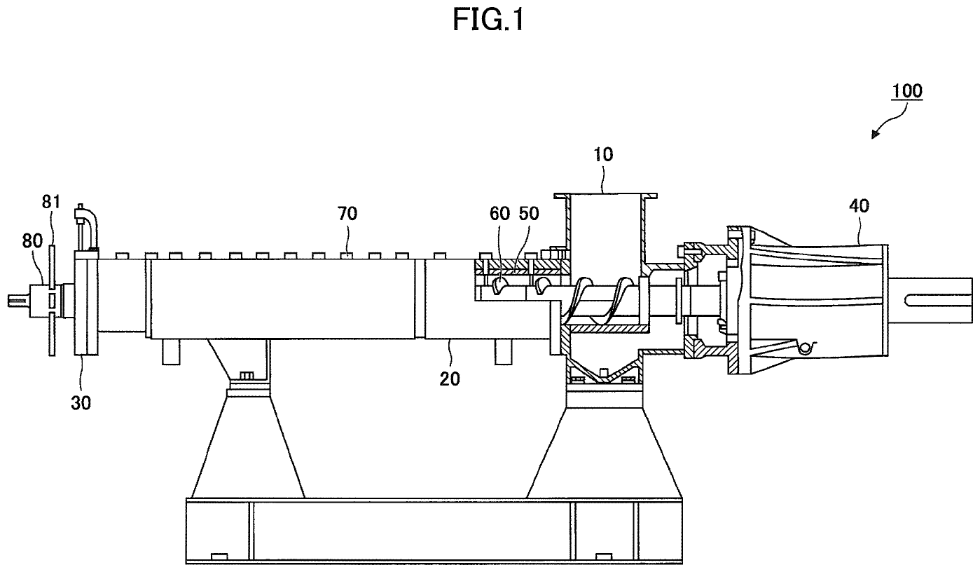

FIG. 1 is a diagram illustrating an extrusion dryer according to an embodiment of the present invention. FIG. 1 is a cross-sectional view where a part of the figure is cut away. In FIG. 1, a reference numeral 100 is an expansion type extrusion dryer used in this embodiment.

The extrusion dryer 100 is an extrusion dryer configured to dry rubbery polymers, and includes a cylinder 20, a die 30, a liner 50, a screw 60, and a cutter 80. Note that the cylinder 20, die 30, liner 50, and screw 60 are examples of a cylinder, a die, a liner, and a screw that form part of the rubbery polymer extrusion dryer according to the present invention.

The cylinder 20 is cylindrical and has a hopper 10 at one end to supply a rubbery polymer (rubbery crumb) and a die 30 with nozzles 31 forming openings (outlets) at the other end.

The cylinder 20 is provided with a not illustrated jacket having a steam function around the cylinder 20 such that the cylinder 20 is heated by the heat of steam or cooled by water.

The cylinder 20 is provided with breaker bolts 70. The breaker bolts 70 are hermetically embedded in a predetermined spacing axially of the cylinder 20 such that tips protrude from the liner 50 radially inwardly of the cylinder 20 from a lateral side of the cylinder 20. Note that protruding positions of the breaker bolts 70 are defined to correspond to screw pitches of a screw 60 such that the breaker bolts 70 do not contact flights (blades) of the screw 60.

A rubbery polymer (rubbery crumbs) is, for example, of crumbs of a rubbery polymer containing moisture, which is obtained after the rubbery polymer has been dehydrated. Such a rubbery polymer is an example of a rubbery polymer extruded by a rubbery polymer extrusion dryer according to the present invention. For example, the rubbery polymer with moisture content of 5 to 40% may be used for crumbs of the rubbery polymer containing such moisture.

The liner 50 is provided on an inner peripheral surface of the cylinder 20.

The screw 60 is rotatably disposed within the liner 50. At a part of liner 50, a rubbery polymer is conveyed by rotation of the screw 60.

A screw (worm) 60 is rotatably disposed within the liner 50. The screw 60 may be driven by an actuator 40 and rotated so as not to contact the inner surface of the liner 50 within the cylinder 20. The screw 60 has predetermined screw pitch and diameter.

The rubbery polymer fed into the cylinder 20 is conveyed by the screw 60 toward the die 30 within the liner 50. The screw 60 includes a conveyance section 22A and a compression section 22B, which will be described later, and the pitch and the diameter of the screw 60 differ between the conveyance section 22A and the compression section 22B (see FIG. 14). For example, the pitch and the diameter of the screw 60 differ between the conveyance section and the compression section so as to set a volume of space within the liner 50 for conveying a rubbery polymer at the conveyance section by one rotation of the screw 60 to be greater than 1.2 times a volume of space within the liner 50 for conveying a rubbery polymer by one rotation of the screw 60 at the compression section.

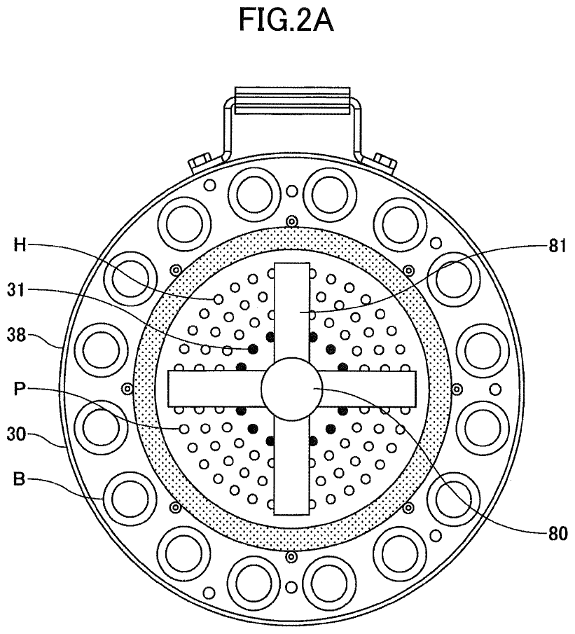

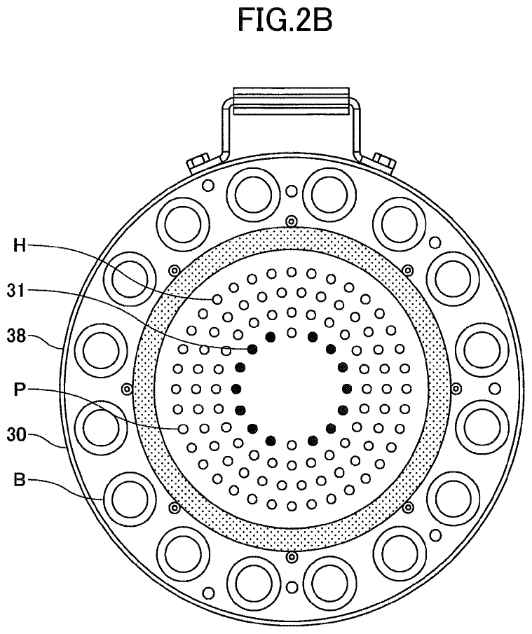

As a result, the rubbery polymer conveyed from the conveyance section to the compression section is subjected to compression action. At the same time, a rubbery polymer is sheared and kneaded between a flight end face of the screw 60 and tips of the breaker bolts 70. The rubbery polymer extruded from the die 30 is then cut with a cutter 80 into pellets or the like. The cutter 80 includes four blades 81. The cutter 80 is spaced apart from the die 30 such that each blade 81 does not contact the die 30 (see FIGS. 1 and 2A).

Heat propagated from a not illustrated jacket and external power for rotating the screw 60 are both partially converted into pressure and temperature of the rubbery polymer. The rubbery polymer is conveyed to the die 30 at high temperature and high pressure and is extruded to an open air from the nozzles 31 of the die 30. At this point in time, a vapor such as moisture is explosively released to an open air, and a moisture content of the rubbery polymer rapidly decreases, resulting in performance of drying (expansion drying).

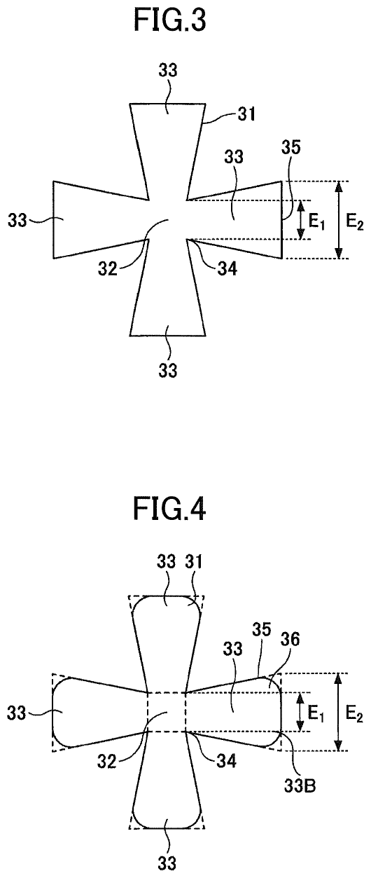

FIGS. 2A and 2B are each a schematic diagram illustrating a die in an extrusion dryer according to present embodiment. FIG. 3 is a diagram illustrating a shape of a die nozzle (first embodiment) in an extrusion dryer according to the present embodiment.

In the extrusion dryer according to the present embodiment, a plurality of nozzles 31 are provided in the die 30 as illustrated in FIG. 3. The nozzles 31 of the die 30 are formed by a plurality of holes H provided on the die 30, as illustrated in FIGS. 2A and 2B. That is, a hole H provided on the die 30 functions as a nozzle 31 of the die 30. In addition, a plug P is inserted into a hole H that does not required to function as a nozzle 31, so that the hole H is occluded.

As illustrated in FIGS. 2A and 2B, the die 30 is attached to one end of the cylinder 20 by tightening the periphery 38 of the die 30 with bolts B to a not-illustrated flange disposed on the end of the cylinder 20.

As illustrated in FIG. 3, each nozzle 31 of the die 30 has a base space 32 and an extended space 33. The base space 32 forms a rectangular shape disposed at the center of the nozzle 31. Further, the extended space 33 is configured as four extended spaces 33 in communication with the base space 32.

Each extended space 33 has a shape with an opening width expanding in a direction away from the base space 32. The direction away from the base space 32 indicates a direction in which each extended space 33 extends from base space 32. Further, the opening width indicates a width of a space in a direction perpendicular to a direction extending from the base space 32 when viewing a nozzle 31 in planar view, as illustrated in FIG. 3. That is, each extended space 33 widens with distance from the base space 32. Further, to have a shape with an expanding opening width may simply indicate to a part of the shape of the extended space 33.

In the extrusion dryer 100, causing a rubbery polymer to pass through a die 30 having such nozzles 31 prevents generation of fine powder and allows uniform drying of the rubbery polymer. Note that a nozzle 31, a base space 32, and an extended space 33 are examples of an opening, an opening base, and an extended opening portion of a die according to the present invention.

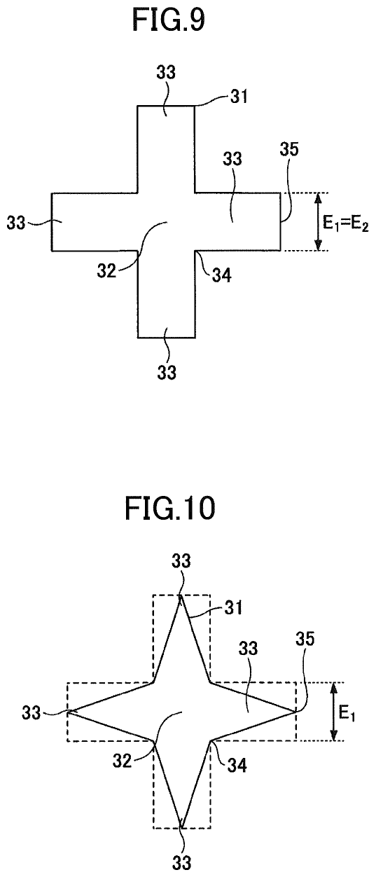

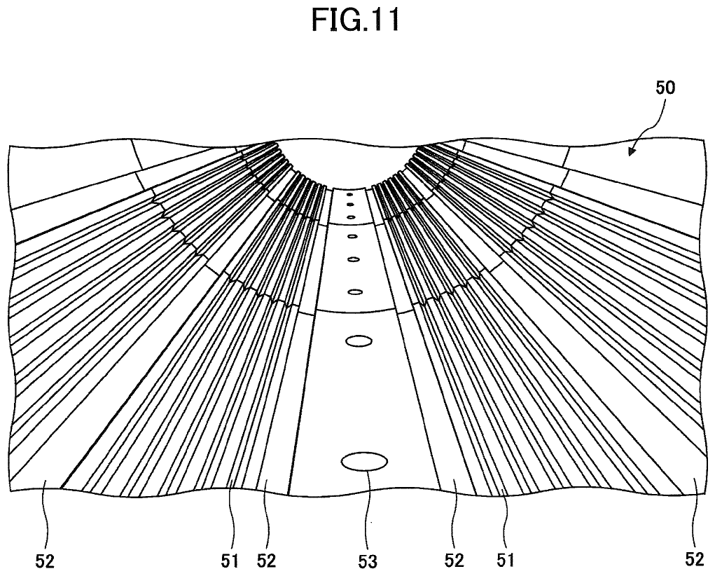

If an opening width of each extended space 33 is constant (see FIG. 9) or is tapered (see FIG. 10), a difference in discharge pressure occurs between a position near the base space 32 of the extended space 33 and a position away from the base space 32 of the extended space 33. That is, at a position of the base space 32 and at a position near the base space 32 of the extended space 33, discharge pressure of a rubbery polymer is lower than that at a position away from the base space 32 of the extended space 33. This makes moisture difficult to evaporate and interferes with uniform drying. In addition, at a position away from the base space 32 of the extended space 33, discharge pressure of a rubbery polymer is higher than a discharge pressure at a position of the base space 32 and at a position near the base space 32 of the extended space 33. This causes shear stress acting on the rubbery polymer to generate fine powder.

By contrast, if the extended space 33 has a shape with an opening width expanding in a direction away from the base space 32, a difference in discharge pressure of a rubbery polymer is unlikely to occur between the position near the base space 32 of the extended space 33 and the position away from the base space 32 of the extended space 33. Accordingly, generation of fine powder is reduced in the extrusion dryer 100, thereby enabling uniform drying of a rubbery polymer.

Further, as illustrated in FIG. 3, according to this embodiment, the extended spaces 33 of the die 30 each have a first end space 34 and a second end space 35. The first end space 34 and the second end space 35 form two opposite ends of the extended space 33, where the first end space 34 is located at a position communicating with the base space 32, and the second end space 35 is located at a position away from the base space 32.

As illustrated in FIG. 3, the first end space 34 and the second end space 35 have a relationship such that a ratio E2/E1 of the opening width E2 at the second end space 35 to the opening width E1 at the first end space 34 is greater than 1. That is, the extended spaces 33 each have an opening width E2 at the second end space 35 greater than an opening width E1 at the first end space 34. Note herein that the first end space 34 and the second end space 35 are examples of a first opening end portion and a second opening end portion in the present invention.

By having the above-described relationship between the opening width E1 at the first end space 34 and the opening width E2 at the second end space 35 at the first end space 34, the opening width may be increased from the first end space 34 toward the second end space 35. Accordingly, nozzles 31 may be formed by extended spaces 33 each having an opening width expanding in a direction away from the base space 32 so as to reduce generation of fine powder and to perform uniform drying of a rubbery polymer.

The ratio E2/E1 of the opening width E2 at the second end space 35 to the opening width E1 at the first end space 34 is, though not particularly limited to, preferably 1.05 to 3.00, more preferably 1.10 to 2.00, and still more preferably 1.20 to 1.60. If the value of the ratio E2/E1 is too high, drying may be reduced near the second end space 35 of each of the nozzles 31 (extended spaces 33). Further, if the value of the ratio E2/E1 is too low, generation of fine powder may increase.

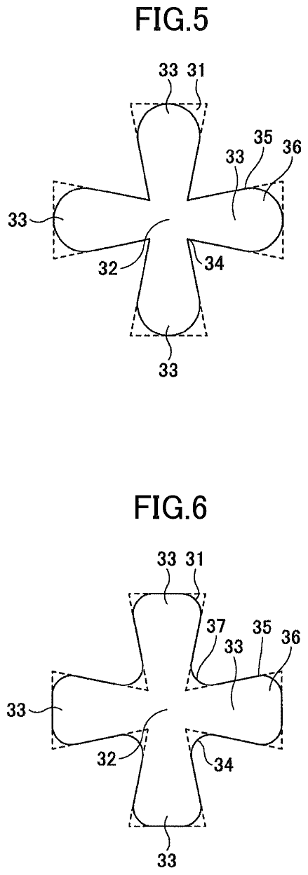

FIG. 4 is a diagram illustrating a shape of a die nozzle (second embodiment) in an extrusion dryer according to the present embodiment. FIG. 5 is a diagram illustrating a shape of a die nozzle (third embodiment) in an extrusion dryer according to the present embodiment.

In these embodiments, the second end space 35 may further be communicated with an additional arc-shaped extended space 36. The shape of the additional arc-shaped extended space 36 may be any shape, for example, two corners of an end away from the base space 32 of the extended space 33 may be curved by being rounded as illustrated in FIG. 4. Further, as illustrated in FIG. 5, an entire end away from the base space 32 of the extended space 33 may be rounded without leaving any straight portions.

The presence of corners at the second end space 35 may cause a rubbery polymer to tear away from the corners or may cause a large shear stress to be applied to the rubbery polymer when the rubbery polymer is extruded from the nozzle 31. In the present embodiment, since no corners are formed at the second end space 35 by having such an additional arc-shaped extended space 36 communicating with the second end space 35, it is possible to prevent rubber from being torn or to prevent a rubbery polymer from being subjected to a large shear stress. Accordingly, it is possible to reliably prevent generation of fine powder. Note that the additional extended space 36 is an example of an additional extended opening portion according to the present invention.

FIG. 6 is a diagram illustrating a shape of a die nozzle (fourth embodiment) in an extrusion dryer according to the present embodiment. As illustrated in FIG. 6, a boundary space 37 connecting the base space 32 and the extended spaces 33 is preferably shaped to have no corners. A boundary space 37 includes portions of communication of the first end space 34 of the extended space 33 with the base space 32 in the die 30. The boundary space 37 of the extended spaces 33 with the base space 32 may have any shape, for example, the boundary space 37 of the extended spaces 33 with the base space 32 may be rounded to be a curved shape, as illustrated in FIG. 6.

The boundary space 37 of the first end space 34 of the extended space 33 with the base space 32 is shaped so as not to form such corners. As a result, shear stress applied to a rubbery polymer when the rubbery polymer is extruded from the nozzle 31 decreases even at the center of the nozzle 31, thereby further reducing generation of fine powder.

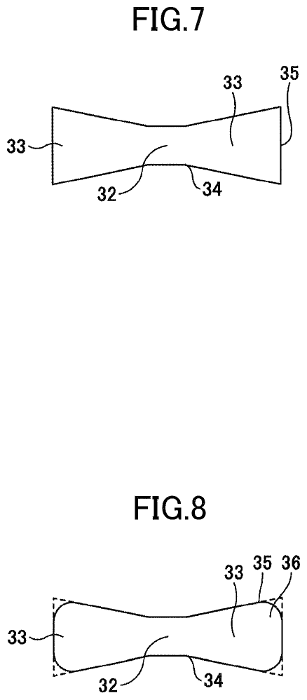

FIG. 7 is a diagram illustrating the shape of a die nozzle (fifth embodiment) in an extrusion dryer according to this embodiment. FIG. 8 is a diagram illustrating a shape of a die nozzle (sixth embodiment) in an extrusion dryer according to the present embodiment. The nozzle 31 of the die 30 may, for example, have at least one extended space 33, and the number of extended spaces 33 is not particularly specified. The shape of the nozzle 31 is not particularly specified. For example, as illustrated in FIGS. 3 to 6, each of the nozzles 31 may include four extended spaces 33. Likewise, as illustrated in FIGS. 7 and 8, each of the nozzles 31 may include two extended spaces 33.

When the nozzle 31 is configured to have four extended spaces 33, a shape of the nozzle 31 is preferably a cross shape (intersection shape), as illustrated in FIGS. 3 to 6. The cross shape nozzles 31 are easy to design. In addition, by employing the cross shape nozzles 31, the four extended spaces 33 may be evenly formed relative to the base space 32, and uniform drying of a rubbery polymer may be possible.

When the nozzle 31 is configured to have two extended spaces 33, a shape of the nozzle 31 is preferably an array form (linear shape), as illustrated in FIGS. 7 and 8. Such array type nozzles 31 are also easy to design. In addition, since the two extended spaces 33 may be evenly formed relative to the base space 32 by employing the array type nozzles 31, uniform drying of the rubbery polymer can be performed.

Note that as illustrated in FIG. 8, to use nozzles 31 each having two (array-type) extended spaces 33, it is preferable that an additional arc-shaped extended space 36 be formed (rounded) at the second end space 35 of the extended space 33 from a viewpoint of reducing shear stress applied to a rubbery polymer. It is also preferable to use nozzles 31 each having no corners in the boundary space 37 of the first end space 34 with the base space 32.

Next, a configuration of the liner 50 will be described. FIG. 11 is an enlarged view illustrating a portion of an inner surface of a liner that forms part of an extrusion dryer of the present embodiment. As illustrated in FIG. 11, a plurality of grooves is preferably formed on the inner surface of the liner 50. In this embodiment, two types of grooves (grooves 51 and 52) are formed, respectively. In this case, the grooves 51 and 52 are formed to extend in a direction (conveyance direction) in which the crumbs are conveyed. In addition, holes 53 for attaching the breaker bolts 70 are formed between some adjacent grooves 52.

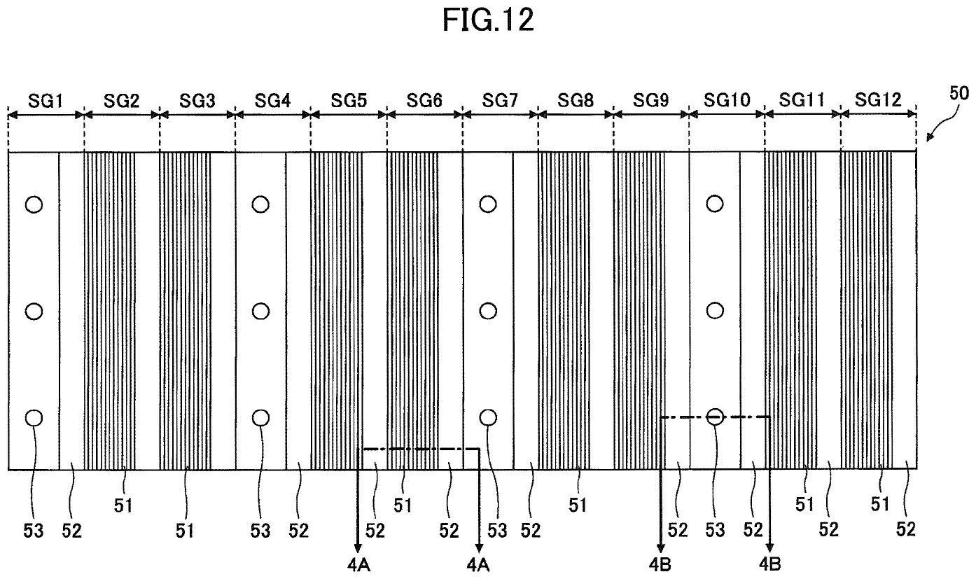

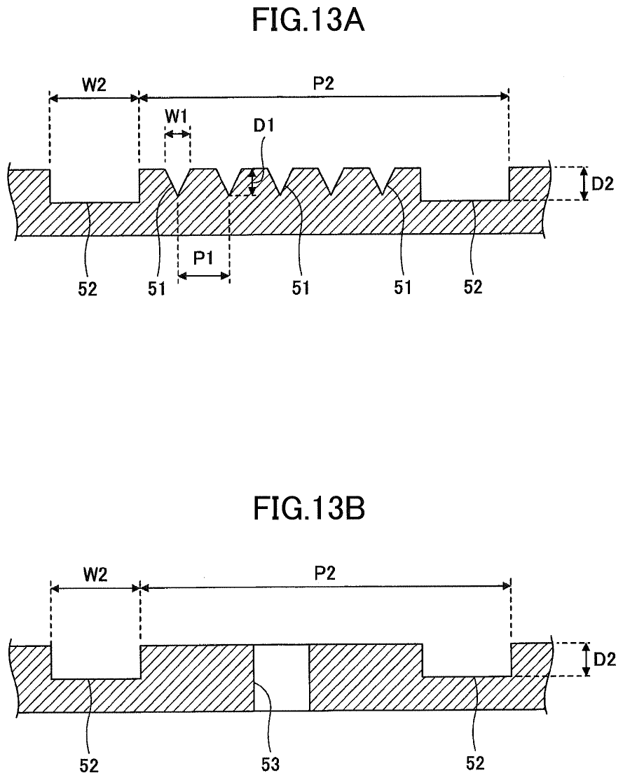

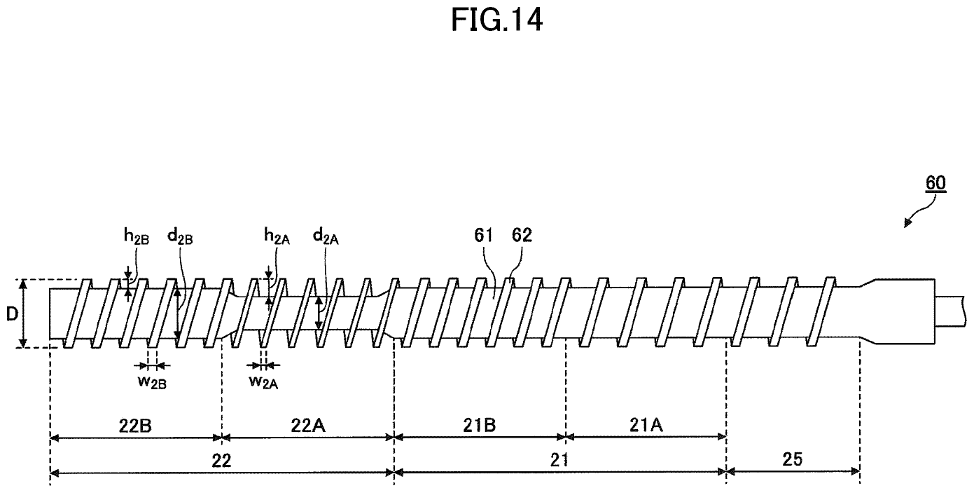

FIG. 12 is a diagram illustrating an extrusion dryer (first embodiment) according to the present embodiment in which a portion of a liner is expanded. FIG. 13A is a cross-sectional view cut along a 4A-4A line of FIG. 12, and FIG. 13B is a cross-sectional view cut along a 4B-4B line of FIG. 12. As illustrated in FIG. 12, a portion of the liner 50 forming a conveyance section may have 12 segments (segments SG1 to SG12). Of the 12 segments, eight segments (segments SG2, SG3, SG5, SG6, SG8, SG9, SG11, and SG12) each have multiple grooves 51. In this embodiment, five grooves 51 are provided in each segment.

Further, all the 12 segments (segments SG1 to SG12) are provided with grooves 52. In this embodiment, one groove 52 is provided in each segment.

In addition, the segments SG1, SG4, SG7, and SG10 are provided with holes 53 for attaching the breaker bolts 70. Although three holes 53 are provided in each segment, the number of holes per segment may be suitably determined in relation to pitch and size of a diameter of a screw.

Each groove 51 is made with a predetermined width W1, as illustrated in FIG. 13A. The width W1 of the groove 51 is not particularly specified, but may preferably be defined to be between 0.1 mm or more and 2 mm or less, and more preferably be defined to be between 1.0 mm or more and 2.0 mm or less. As used herein, a width of a groove indicates an opening width of a groove that opens an inner surface of the liner (see FIGS. 12 and 13).

Providing such grooves 51 allows water to be easily separated from a rubbery polymer during conveying the rubbery polymer to escape into the grooves 51. An example of such a rubbery polymer may be a rubber material (crumbs) obtained after dehydration. Accordingly, a water film is less likely to form between a rubbery polymer and the liner 50, making it possible to improve frictional force between the rubbery polymer and the liner 50.

This prevents the rubbery polymer from residing in the liner or leaking from a feeder during extrusion drying of the rubbery polymer. Accordingly, use of the extrusion dryer according to the present embodiment enables stable conveyance of a rubbery polymer within the extrusion dryer, thereby improving drying efficiency.

When the width W1 of the groove 51 is less than 0.1 mm, sufficient space for the groove 51 cannot be obtained to allow the separated water to escape into the groove 51 within a conveyance section. When the groove width W1 exceeds 2 mm, the rubbery polymer intrudes into the groove 51, thereby narrowing a space for a groove 51 to inhibit the separated water from escaping into the groove 51.

Each groove 51 is made with a predetermined pitch P1 as illustrated in FIG. 13A. The pitch P1 of the groove 51 is not particularly specified, but is preferably defined to be between 0.5 mm or more and 25 mm or less. As used herein, the pitch of a groove indicates spacing between two adjacent grooves (see FIGS. 4 and 5).

By providing grooves 51 having such a pitch, the grooves 51 for allowing separated water to escape may be formed within a limited area of the inner surface of the cylindrical liner 50 without deficiency. Accordingly, a water film is further less likely to form between a rubbery polymer and the liner 50, making it possible to reliably improve a frictional force between the rubbery polymer and the liner 50.

This reliably prevents a rubbery polymer from residing in the liner or leaking from the feeder during extrusion drying of the rubbery polymer. Accordingly, use of the extrusion dryer according to the present embodiment reliably enables stable conveyance of a rubbery polymer within the extrusion dryer, thereby further improving drying efficiency.

When the pitch P1 of the groove 51 is less than 0.5 mm, the number of grooves 51 provided on the inner surface of the cylindrical liner 50 increases, and an area of a portion having no grooves 51 on the inner surface of the liner 50 decreases. Thus, a contact area between a rubbery polymer to be conveyed and the liner 50 is reduced, and a frictional force required for conveying may not be obtained between the rubbery polymer and the liner 50. Further, if the pitch P1 of a groove exceeds 25 mm, the number of grooves 51 provided on the inner surface of the cylindrical liner 50 decreases, and sufficient space for allowing separated water to escape may not be obtained.

Each of the grooves 51 is made with a predetermined depth D1 as illustrated in FIG. 13A. The depth D1 of a groove 51 is not particularly specified, but may preferably be defined to be between 0.05 mm or more and 1.0 mm or less, and be more preferably between 0.1 mm or more and 1.0 mm or less. As used herein, the depth of a groove indicates a distance between an opening of the groove on an inner surface of a liner and a bottom of the groove (see FIGS. 4 and 5).

By providing a groove 51 having such a depth, space for allowing separated water to escape may be obtained within a limited area of an inner surface of the cylindrical liner 50. Accordingly, a water film is further less likely to form between a rubbery polymer and the liner 50, making it possible to further improve a frictional force between a rubbery polymer and the liner 50.

This more reliably prevents a rubbery polymer from residing in the liner or leaking from a feeder during extrusion drying of the rubbery polymer. Accordingly, use of the extrusion dryer according to the present embodiment enables further stable conveyance of a rubbery polymer within the extrusion dryer, thereby further improving drying efficiency.

When the depth D1 of the groove 51 is less than 0.05 mm, the depth of each groove is too shallow to obtain sufficient space for the grooves to allow water separated from the rubbery polymer to escape. If the depth D1 of the groove 51 exceeds 1.0 mm, the thickness between the bottom of the groove 51 and an outer surface of the liner 50 may be reduced, thereby reducing the strength of the liner 50. Further, if the depth D1 of each groove 51 exceeds 1.0 mm, a rubbery polymer may intrude into the grooves 51, and the rubbery polymer remaining in the liner 50 for a long period of time thereafter may be peeled off from the grooves 51. Thus, such a degraded rubbery polymer may be mixed into the rubbery polymer being conveyed.

In this embodiment, the width W1 and the depth D1 of all the grooves 51 have the same dimensions. The pitch P1 of adjacent grooves 51 in each segment has the same dimension. However, the width W1, the pitch P1, and the depth D1 of the groove 51 may be different within the above-described respective ranges of the width W1, the pitch P1, and the depth D1.

In this embodiment, the grooves 51 are provided in eight segments, but the grooves 51 may be provided in at least one segment. The groove 51 is an example of a plurality of grooves in an extrusion dryer of the present invention.

The cross-sectional shape of the groove 51 is not particularly specified, and may, for example, be semi-circular, U-shaped, triangular, V-shaped, rectangular, trapezoidal, inverted trapezoidal, and the like. As used herein, the cross-sectional shape of a groove indicates a shape in a cross-section perpendicular to a groove extending direction (see FIGS. 12, 13A, and 13B).

It is preferable that the cross-sectional shape of the groove 51 be a V-shape, from a viewpoint of inhibiting the rubber-shaped polymer being retained within the grooves 51. Such a cross-sectional shape of the groove 51 makes it difficult for a rubbery polymer to reside at the bottom of the groove 51, and makes it difficult for the rubbery polymer to reside in the groove 51 even if the rubbery polymer enters the groove 51. Thus, it is possible to prevent a decrease in the conveyance efficiency of the rubbery polymer.

Further, as illustrated in FIGS. 11 to 13B, grooves having dimensions differing from the dimensions of the grooves 51 may be provided on the inner surface of the liner 50. In this case, grooves having dimensions differing from the dimensions of the grooves 51 include grooves having a width greater than the width of grooves 51 and grooves having a width smaller than the width of grooves 51. In this embodiment, a groove 52 having a width greater than the width of the groove 51 may be formed. Each groove 52 is made with a predetermined width W2, a predetermined pitch P2, and a predetermined depth D2, as illustrated in FIGS. 13A and 13B. The groove 52 is another example of a plurality of grooves in an extrusion dryer of the present invention.

The dimensions of the width W2 and the pitch P2 of the groove 52 may optionally be set in relation to the width W1 and the pitch P1 of the groove 51. The depth D2 of the groove 52 may optionally be set in view of the thickness of the liner 50. In this embodiment, the width W2, the pitch P2, and the depth D2 of all the grooves 52 have the same dimensions. However, the width W2, the pitch P2, and the depth D2 with respect to each of the grooves 52 may be different.

By providing a groove 52 having such a width dimension greater than the groove 51, a volume of space for allowing a rubbery polymer to be conveyed in the liner 50 may be increased. This may increase the amount of rubbery polymer to be conveyed. The provision of such grooves 52 in the liner 50 also generates frictional force between the rubbery polymer and the liner 50 because the step shape of the grooves 52 causes resistance against a rotational direction of the screw 60 (in a circumferential direction of the liner 50).

In this embodiment, a direction in which the grooves 51 and 52 extend is substantially parallel to an axial direction of the cylinder 20, as illustrated in FIGS. 11 and 12. However, in the case where the conveyance direction of a rubbery polymer is not parallel to the axial direction of the cylinder 20, such a direction may be defined as not being parallel to the axial direction of the cylinder 20. For example, if a direction in which a rubbery polymer is actually conveyed by rotation of the screw 60 is a direction that extends at a predetermined angle with respect to the axial direction of the cylinder 20, the direction in which the grooves 51 and grooves 52 extend may be defined as such an extending direction at the predetermined angle.

In the liner 50 illustrated in FIGS. 12, 13A, and 13B, no grooves 51 are provided in the segments SG1, SG4, SG7, and SG10, where holes 53 for attaching the breaker bolts 70 are provided. By contrast, the segments SG1, SG4, SG7, and SG10 provided with holes 53 may be provided with grooves 51A having the same dimensions as the width W1, the pitch P1, and the depth D1 of the grooves 51. This configuration may substantially increase the number of grooves 51 to be provided throughout liner 50. As a result, more space is provided within the liner 50 corresponding to a conveyance section for water separated from a rubbery polymer to escape, thereby allowing more stable conveyance of the rubbery polymer.

In the liner 50 illustrated in FIGS. 12, 13A, and 13B, two grooves 51A are provided in each of the segments SG1, SG4, SG7, and SG10. However, the number of grooves 51A may be optionally increased or decreased in relation to the width W1, the pitch P1, and the depth D1 of the grooves 51. For example, 11 grooves 51A may be provided in each of the segments SG1, SG4, SG7, and SG10, with a total number of 44 grooves 51A being provided throughout the liner 50.

Further, in the liner 50 illustrated in FIGS. 12, 13A, and 13B, grooves 52 are provided in all 12 segments (segments SG1 to SG12). However, the grooves 51 with the same dimensions with respect to the width W1, the pitch P1, and the depth D1 may be provided instead of providing the grooves 52. In this case, the grooves 51A may preferably be provided in respective segments SG1, SG4, SG7, and SG10.

This configuration may further increase the number of grooves 51 provided throughout the liner 50. Accordingly, the interior of the liner 50 corresponding to a conveyance section may further increase space for allowing water separated from the rubbery polymer to escape, which enables stable conveyance of a rubbery polymer even if conveying a rubbery polymer having high moisture content.

Next, a configuration of the screw 60 will be described. FIG. 14 is a schematic diagram illustrating a screw in an extrusion dryer of the present embodiment. The screw 60 is driven by an actuator 40, and is rotatably arranged in the cylinder 20 while having a prescribed gap between an inner surface of the cylinder 20 and the screw 60. An inner diameter of the cylinder 20 is approximately constant, except within the vicinity of the die 30. The screw 60 includes a shaft 61 and flights 62.

The rubbery polymer is conveyed in the cylinder 20 toward the die 30, by rotation of the screw 60. During the conveyance, the rubbery polymer is heated and pressed because the rubbery polymer is sheared and pressed between a liner in the cylinder 20 and flights 62 of the screw 60, or between breaker bolts 70 and the flights 62 of the screw 60. The rubbery polymer may be heated with a heating unit provided at the cylinder 20 and/or a shaft 61 of the screw 60.

In the cylinder 20, the moisture-containing rubbery polymer, to which high heat and high pressure are applied, is conveyed to the die 30, and is ejected to an open air from nozzles of the die 30. At this point in time, as moisture or the like at high-temperature and high-pressure contained in the rubbery polymer is vaporized at a time and emitted to an open air, the rubbery polymer dries (expansion drying).

As illustrated in FIG. 14, the screw 60 includes a hollow shaft 61, and helical flights (blades) 62 projecting on an outer surface of the shaft 61. As notches are provided on the flights 62, the flights 62 have a discontinuous helical structure. Because of such a discontinuous helical structure, the flights 62 do not contact the breaker bolts 70 that protrude from a lateral surface of the cylinder 20 in a radial direction toward an inner side of the cylinder 20. In the case where the extrusion dryer 100 does not include the breaker bolts 70, the flights 62 may have a continuous helical structure.

The screw 60 of the extrusion dryer 100 illustrated in FIG. 14 includes two zones, that is, a first zone 21 and a second zone 22. The first zone 21 includes a conveyance section 21A and a compression section 21B adjacent to the conveyance section 21A at a position closer to the hopper 10. The second zone 22 which is the closest to the die 30 includes a conveyance section 22A and a compression section 22B adjacent to the conveyance section 22A at a position closer to the hopper 10. A hopper section 25 is provided at a region adjacent to an end of the first zone 21 at a position closer toward the hopper 10.

In the extrusion dryer 100 of the present embodiment, since the screw 60 includes the multiple zones 21 and 22 each including a conveyance section and a compression section, temperature and pressure increase gradually. Thus, high-temperature and high-pressure areas are dispersed, and fluctuations of load applied to a compression section and a conveyance section adjacent to the die may be reduced.

Although a rubbery polymer containing a large amount of moisture exhibits solid body properties, since uniformity of a material is low, the rubbery polymer is susceptible to localized heating. Further, since a rubbery polymer containing large amount of moisture has low heat conductivity, a temperature distribution and a pressure distribution would tend to occur; hence, the rubbery polymer would not be conveyed stably, and surging (a condition in which an extrusion dryer stalls due to a backward flow and stops working) would occur. By increasing uniformity while applying temperature and pressure in the first zone, and by further increasing the uniformity in the second zone, amount of conveyance, uniformity of temperature distribution, and uniformity of pressure distribution may be gradually increased, and a rubbery polymer may be expanded in a uniform state. As a result, when the rubbery polymer is extruded from the die 30 of the extrusion dryer, a uniformly dried rubbery polymer may be obtained. By providing multiple zones, repetition of increase of temperature and pressure may be performed twice or more. Three or more zones may be provided in accordance with the quality of material to be dried.

In the present embodiment, at the second zone 22, which is the closest to the die 30, a shaft outer diameter d_{2A} of the shaft 61 (inner diameter of the screw 60) at the conveyance section 22A is smaller than a shaft outer diameter d_{2B} of the shaft 61 at the compression section 22B. As an outer diameter D of the screw 60 (outer diameter of the flights 62) is constant in the extrusion dryer 100 illustrated in the drawings, and diameters of the shaft 61 in the second zone 22 have the above-described relationship, a height h_{2A} of the flights 62 at the second conveyance section 22A can be higher than a height h_{2B} of the flights 62 at the second compression section 22B. Note that a height h of the flight (flight height) of the screw 60 corresponds to a difference obtained by subtracting an outer radius d/2 of the shaft 61 from an outer radius D/2 of the screw 60 (outer radius of the flights 62).

Amount of heat generated by conveyance of a rubbery polymer in the cylinder 20 is proportional to a square of shear rate. Shear rate is proportional to velocity in a direction of shear stress applied to a rubbery polymer, which is rotational speed (of the screw 60), and shear rate is inversely proportional to a height of a flights (flight height) h. Thus, if the flight height h is increased, shear rate decreases, and heat to be generated also decreases. Therefore, as described above, if the shaft outer diameter d_{2A} at the second conveyance section 22A is made smaller than the shaft outer diameter d_{2B} at the second compression section 22B, heat to be generated (heat that is inevitably generated) may be decreased. As a result, excessive temperature increase of a rubbery polymer can be prevented, and deterioration (gelation) can be lowered.

Further, in the second zone 22, by making the shaft outer diameter d_{2A} at the conveyance section 22A smaller than the shaft outer diameter d_{2B} at the compression section 22B, a capacity of the conveyance section 22A (volume of material that can be stored in the conveyance section 22A) increases, and conveyed volume V_{2A} also increases. As a result, at the second zone 22, a ratio of the conveyed volume V_{2A} at the conveyance section 22A to conveyed volume V_{2B} at the compression section 22B (conveyed volume ratio or compression ratio (V_{2A}/V_{2B})) may be increased. That is, a degree of compression of a rubbery polymer at the compression section 22B may be increased. Accordingly, since pressure of a rubbery polymer after passing through the compression section may be increased, the moisture evaporation rate when a rubbery polymer is extruded may also be increased, and drying may be facilitated. For example, if a rubbery polymer having moisture content of approximately 40% by mass is dried by extrusion, the moisture content of the rubbery polymer may become 10% by mass or less.

As described above, according to the present embodiment, while degradation of a rubbery polymer may be prevented by controlling excessive temperature increase, pressure necessary for drying may also be obtained. Thus, a high quality rubbery polymer may be stably produced.

In the present embodiment, since the extrusion dryer 100 is configured to have the above-described relationship (d_{2A}<d_{2B}) in a zone closest to the die 30, the extrusion dryer 100 may be able to appropriately control temperature and pressure of a rubbery polymer at a position immediately before the rubbery polymer is extruded (or temperature and pressure at an outlet of a rubbery polymer), which are especially important factors for production of a rubbery polymer.

Further, in the extrusion dryer 100 according to the present embodiment, since generation of unnecessary heat may be reduced, the rotational speed N of the screw 60 may be increased for example, as compared to related art extrusion dryers. Accordingly, the amount of a dried rubbery polymer obtained per unit time may be increased, and productivity may also be improved.

In the second zone 22, the pitch of the flights 62 of the screw 60 is substantially constant, as illustrated in FIG. 14. That is, in the second zone 22, a conveyed volume ratio (V_{2A}/V_{2B}) is increased not by changing pitch of the flights 62 between the second conveyance section 22A and the second compression section 22B, but by changing the outer diameter d of the shaft 61 between the second conveyance section 22A and the second compression section 22B.

Note that if the pitch of the flights 62 at the second conveyance section 22A is greater than the pitch of the flights 62 at the second compression section 22B, the conveyed volume ratio (V_{2A}/V_{2B}) in the second zone 22 increases. However, the amount of heat generated increases due to increase in the shear rate. Thus, temperature of a rubbery polymer at a position immediately before the rubbery polymer is extruded may excessively increase, and temperature may fail to be controlled appropriately.

However, the pitch of the flights 62 at the second conveyance section 22A may differ from the pitch of the flights 62 at the second compression section 22B, if, by configuring the shaft outer diameter d_{2A} at the second conveyance section 22A to be smaller than the shaft outer diameter d_{2B} at the second compression section 22B, unnecessary heat generation is reduced.

It is preferable that the shaft outer diameter d_{2A} at the second conveyance section 22A in the second zone 22 remains constant throughout the entirety of the conveyance section 22A, from an end of the second conveyance section 22A at a position closer to the hopper 10 to the other end of the second conveyance section 22A at a position closer to the die 30. However, as illustrated in FIG. 14, the shaft 61 may be designed such that a reverse taper is formed on the shaft 61 at these two ends of the conveyance section 22A. In this case, the shaft outer diameter d_{2A} may be a shaft outer diameter of a middle portion between an end of the second conveyance section 22A at a position closer to the hopper 10 and the other end of the second conveyance section 22A at a position closer to the die 30, where a shaft diameter is substantially constant.

In the second conveyance section 22A of the second zone 22, the conveyed volume V_{2A} may be the conveyed volume of a middle portion of the second conveyance section 22A between an end of the screw 60 at a position closer to the hopper 10 and the other end of the screw 60 at a position closer to the die 30, where a shaft outer diameter is substantially constant.

In the present embodiment, a ratio of the shaft outer diameter d_{2B} at the compression section 22B to the shaft outer diameter d_{2A} at the conveyance section 22A is preferably between 1:0.8 and 1:0.98, and more preferably between 1:0.85 and 1:0.96. If the ratio is 1:0.98 or lower, high conveyed volume ratio (V_{2A}/V_{2B}) at the second zone 22 may be attained and effect for obtaining pressure for drying may be enhanced, while reducing generation of unnecessary heat in the dryer and avoiding excessive temperature increase. Thus, deterioration (gelation) of a rubbery polymer may be avoided, and higher drying efficiency may be attained.

In addition, if the ratio is 1:0.8 or larger, strength of the shaft 61 sufficient for an extrusion operation of a rubbery polymer may be obtained.

At the second zone, which is the closest to the die 30, a width (thickness) w_{2A} of the flights 62 (flight width) at the second conveyance section 22A is preferably smaller than a width w_{2B} of the flights 62 at the second compression section 22B. This is because the volume in the second conveyance section 22A (volume of material that may be accommodated in the conveyance section 22A) can be increased, and the conveyed volume ratio (V_{2A}/V_{2B}) at the second zone 22 may be increased. Thus, in a case in which the flight width w_{2A} at the second conveyance section 22A is configured to be smaller than the width w_{2B} of the flights 62 at the second compression section 22B, from the perspective of increasing the conveyed volume ratio (V_{2A}/V_{2B}), the shaft outer diameter d_{2A} at the conveyance section 22A does not need to be reduced by the proportion of the conveyed volume ratio corresponding to reduction of the flight width w_{2A}. That is, the conveyed volume ratio (V_{2A}/V_{2B}) may be increased while maintaining strength of the shaft 61 of the screw 60.

A ratio of the flight width w_{2B} at the second compression section 22B to the flight width w_{2A} at the second conveyance section 22A is, though depending on sizes of the extrusion dryer 100 and the screw 60, preferably between 1:0.4 and 1:0.8, and more preferably between 1:0.45 and 1:0.6. If the ratio is 1:0.6 or lower, the conveyed volume ratio may be increased, and pressure of a rubbery polymer that is immediately before being extruded may be increased. Further, if the ratio is 1:0.4 or larger, strength of the shaft 61 of the screw 60 and strength of the flights 62 themselves may be secured.

Even if w_{2A} is configured to be smaller than w_{2B}, the pressure applied from a rubbery polymer to the flights 62 at the second conveyance section 22A is smaller than the pressure applied to the flights 62 at the second compression section 22B; thus, the effect on the strength of the flights 62 is small.

In the present embodiment, at the second zone 22, which is the closest to the die 30, a ratio of volume V_{2B} of a rubbery polymer conveyed at the second compression section 22B in a single revolution of the screw to volume V_{2A} of a rubbery polymer conveyed at the second conveyance section 22A in a single revolution of the screw is preferably larger than 1:1. For example, the ratio is preferably between 1:1.1 and 1:5, more preferably between 1:1.5 and 1:2.5, much more preferably between 1:1.6 and 1:2.2, and yet much more preferably between 1:1.8 and 1:2.0. If the ratio is 1:1.1 or larger, the pressure applied to the rubbery polymer that is immediately before being extruded may be increased. As a result, evaporation of moisture in the extruded rubbery polymer is enhanced, and a rubbery polymer having high quality and low moisture content may be obtained. Further, if the ratio is 1:5 or lower, the mechanical strength of the extrusion dryer may be maintained.

In FIG. 14, a structure of the first zone 21 differs from that of the second zone 22. That is, in the first zone 21, a shaft outer diameter at the first conveyance section 21A is equal to a shaft outer diameter at a first compression section 21B. Pitch of the flights 62 at the first conveyance section 21A is greater than pitch of the flights 62 at the first compression section 21B, and a width of the flights 62 is the same in the first conveyance section 21A and the first compression section 21B. In an example of the first zone 21 illustrated in the drawing, the conveyed volume ratio is configured to be larger than 1 by changing pitch of the flights 62 between the conveyance section and the compression section.

However, the first zone 21 may have a structure other than the above-described structure. The first zone 21 may have the same structure as the second zone 22. For example, the shaft outer diameter at the first conveyance section 21A may be smaller than the shaft outer diameter at the first compression section 21B. By adopting this configuration, effect for sufficiently enhancing drying of a rubbery polymer while reducing unnecessary heat generation, which is similar to that obtained at the second zone 22, may be obtained in the first zone 21. As a result, a further higher quality rubbery polymer may be obtained.

In this case, in the first zone 21, similar to the second zone 22, a ratio of the shaft outer diameter at the compression section 21B to the shaft outer diameter at the conveyance section 21A is preferably between 1:0.8 and 1:0.98, and more preferably between 1:0.85 and 1:0.96.

In the first zone 21, a ratio of volume of a rubbery polymer conveyed at the compression section 21A in a single revolution of the screw 60 to volume of a rubbery polymer conveyed at the conveyance section 21B in a single revolution of the screw may be made to 1:1 or larger. The ratio is preferably between 1:1.5 and 1:2.5, more preferably between 1:1.6 and 1:2.2, and much more preferably between 1:1.8 and 1:2.0.

Further, a flight width at the first conveyance section 21A may be smaller than a flight width at the first compression section 21B. A ratio of these flight widths is preferably between 1:0.4 and 1:0.8, and more preferably between 1:0.45 and 1:0.6.

In the embodiment illustrated in FIG. 14, two zones, each of which includes the conveyance section and the compression section, are provided. However, the number of such a zone provided in the extrusion dryer 100 may be three or more. In this case, multiple first zones 21 may be provided at locations closer to an inlet relative to the second zone 22 positioned closest to the die 30. In such a case, for each of the multiple first zones 21, if a shaft outer diameter at the conveyance section 21A is configured to be smaller than a shaft outer diameter at the compression section 21B as described above, unnecessary heat generation can be reduced. Further, in this configuration, since the conveyed volume ratio may be increased for each of the multiple first zones 21, sufficiently high pressure of a rubbery polymer immediately before being extruded may be maintained.

Note that the cylinder 20 and the screw 60 that are used in the above-described embodiment are configured such that inner and outer diameters of the cylinder 20 and an outer diameter of the screw 60 are constant in an axial direction. However, these diameters are not required to be constant. Even in a case in which at least one of these diameters varies in the axial direction, advantageous effects of the present invention capable of performing excellent drying while reducing heat generation in the extrusion dryer 100 may be attained by making the shaft outer diameter d_{2A} at the second conveyance section 22A smaller than the shaft outer diameter d_{2B} at the second compression section 22B, or by making the flight height h_{2A} at the second conveyance section 22A higher than the flight height h_{2B} at the second compression section 22B.

The types of a rubbery polymer that may be dried by extrusion according to the present embodiment are not limited to any specific types. Examples of such a rubbery polymer include: diene-based rubbers, such as butadiene rubber (BR), styrene-butadiene rubber (SBR), isoprene rubber (IR), styrene-isoprene block copolymers (SIS), styrene-butadiene block copolymers (SBS), nitrile butadiene rubber (NBR), and chloroprene rubber (CR); olefin-based rubbers, such as butyl rubber (IIR), ethylene-propylene-diene terpolymer rubber (EPDM), acrylic rubber, chlorosulfonated polyethylene rubber, and fluoro-rubber; silicone rubber; and urethane rubber. The present embodiment is preferably used for drying BR or SBR, among these rubbery polymers.

Further, the moisture content of the rubbery polymer may be reduced by extrusion drying using an extrusion dryer according to the present embodiment to approximately ⅓ or less of the moisture content of the rubbery polymer before undergoing extrusion drying.

For example, a rubbery polymer with moisture content of approximately 25% may be reduced by using an extrusion dryer 100 to moisture content of approximately 10% or less.

Next, a method of drying a rubbery polymer according to the present embodiment will be described. In the drying method of this embodiment, the extrusion dryer 100 described above may be used. Specifically, a rubbery polymer is dried using an extrusion dryer 100 including a die 30 with multiple nozzles 31 at one end of the cylinder 20. In this case, the nozzles 31 are each provided with a base space 32 and at least one extended space 33 in communication with the base space 32, as described above. The extended space 33 also has an opening width expanding in a direction away from the base space 32.

By drying of a rubbery polymer using a drying method according to the present embodiment, as with the extrusion dryer described above, the generation of fine powder during extrusion drying of the rubbery polymer may be reduced and uniform drying of the rubbery polymer may be performed. The drying method of the present embodiment is an example of a method of drying a rubbery polymer of the present invention.

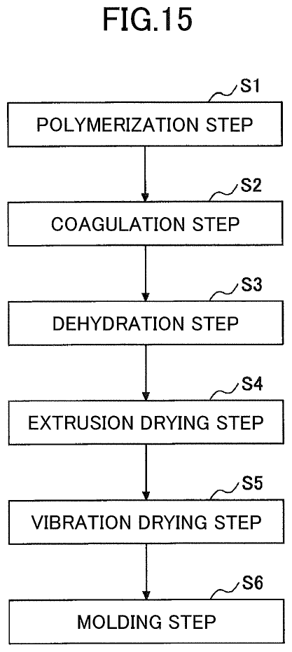

Next, a production method of a rubbery polymer according to the present embodiment will be described. FIG. 15 is a flowchart illustrating an example of a production method of a rubbery polymer according to the present embodiment. As illustrated in FIG. 15, the production method of a rubbery polymer according to the present embodiment includes a polymerization step S1, a coagulation step S2, a dehydration step S3, an extrusion drying step S4, a vibration drying step S5, and a molding step S6. The production method of the present embodiment is an example of a production method of a rubbery polymer of the present invention.

In the polymerization step S1, a rubber raw material such as butadiene is polymerized by a polymerization reaction such as emulsion polymerization and solution polymerization, and solution, latex, or the like, of a rubbery polymer is obtained.

In the coagulation step S2, a slurry of the rubbery polymer is prepared by applying a steam stripping method to the solution or the latex of the rubbery polymer, for devolatization, or by salt coagulation.

In the dehydration step S3, the slurry of the rubbery polymer is dehydrated by using a dehydrator such as an extruder-type squeezer, to obtain crumbs with predetermined moisture content.

In the extrusion drying step S4, the dehydrated crumbs of the rubbery polymer are dried by extrusion, by using the above-described extrusion dryer 100. Specifically, a rubbery polymer is dried using the extrusion dryer 100 including a die 30 having a plurality of nozzles 31 at one end of the cylinder 20. In this case, the nozzles 31 are each provided with a base space 32 and at least one extended space 33 in communication with the base space 32 as described above. The extended space 33 also has opening widths expanding in a direction away from the base space 32. In the extrusion drying step S4, the above-described drying method of a rubbery polymer may be used.

In the vibration drying step S5, the rubbery polymer to which the above-described extrusion drying step S4 has been applied is placed on a moving vibration belt, and the rubbery polymer is heated to dry while applying vibration. The rubbery polymer may be heated by causing the rubbery polymer to directly come into contact with hot air, or by causing the rubbery polymer to indirectly come into contact with a heating medium.

In the molding step S6, the mass of the rubbery polymer to which the vibration drying step S5 has been applied is measured, and the rubbery polymer is formed into a bale with predetermined dimensions, by using a molding machine. The bale may be formed in a rectangular parallelepiped shape having a short side of 36 cm, a long side of 73 cm, and a height of 18 cm.

According to the drying method or the production method of a rubbery polymer in the present embodiment, since unnecessary fine powder generation is reduced in the drying step, the rubbery polymer may be uniformly dried. Hence, degradation of a rubbery polymer may be prevented, and the productivity of the rubbery polymer may be increased.

### EXAMPLES

Hereinafter, the present embodiment will be described further in detail with reference to specific examples. In the following, “parts” and “%” are by weight unless otherwise indicated. Various tests and evaluations were performed according to the following methods.

### [Evaluation of Filter Clogging Time (Fine Powder Amount)]

A duct was positioned 5m away from one end of the extrusion dryer 100 (see FIG. 1) (an outlet where the die 30 is provided), a 200-mesh wire mesh filter was placed in the course of hot air exhausted by the duct, and the time required for the exhaust air volume becoming half from the start of exhaust was measured.

### [Evaluation of Fine Powder Amount]

Using sieves which have 32-16-8-4.75-0.71 mm opening size, approximately 500 g of dropped crumbs was collected at one end (an outlet provided with the die 30) of the extrusion dryer 100, and the collected crumbs were screened. The weights of crumbs with a size of 0.71 to 4.75 mm were expressed in terms of weight percentage as fine powder amount.

### [Heating Loss Evaluation]

In the production method of the rubbery polymer illustrated in FIG. 15, with respect to the rubbery polymer (bale) sampled after the molding step 6, moisture content was measured by a blower type dryer (105° C., 1 hour), and heating loss (%) was calculated. The heating loss was calculated by the expression {[(mass of sample obtained after molding step)−(mass of sample having been dried by blower type dryer)]/(mass of sample obtained after molding step)}×100.

### [Microgel Evaluation]

10 g of the resulting rubbery polymer was dissolved in 300 ml of xylene, screened through a 1 μm filter, and a surface was observed to evaluate the size and number of gels. The largest values are illustrated as representative values in Tables.

[Evaluation of Drying Uniformity] One hundred bales were randomly sampled, and the number of bales with a surface having wet spots of 10 mm or more was counted. The mean of the number of two measured values is illustrated in Tables.

The following illustrates examples and comparative examples.

### Example 1

Solution-polymerized styrene-butadiene rubber with a styrene content of 21%, a vinyl content of 63% by mole in butadiene and a Mooney viscosity of 45 was produced by solution polymerization, according to a conventional method. After adding 0.2 parts of a phenolic antioxidant to the solution-polymerized styrene-butadiene rubber, solvent was removed by steam-stripping method, and rubbery polymer crumbs having a moisture content of 15% and a residual cyclohexane content of 1.5% were obtained by a continuous rotation type screw dehydrator. The resulting crumbs were loaded into the extrusion dryer 100 at a predetermined charge rate (as dry rubber). In addition, the rotational speed of a cutter was controlled to 800 rpm such that the die temperature was 160° C. The conditions of the die 30 included a shape of a nozzle 31 being a cross shape, a ratio E2/E1 of the second end space 35 to the first end space 34 being 1.73, and the number of nozzles 31 being 34. The outlet of the extrusion dryer 100 was connected to a hot air dryer (not illustrated) consisting of three sections, and evaluations were performed using a vibrating conveyor consisting of a first section with a residence time of approximately 0.5 minutes, and a second section and a third section each with a residence time of approximately 2 minutes. Temperature represents the maximum temperature of each section, which was slowly lowered from maximum temperature to approximately 50° C. in the third section. Heating loss was assessed by sampling the rubbery polymer from an outlet of a hot air dryer and drying the sample at 105° C. for 1 hour. The amount of fine powder was collected at the outlet of the first section of the hot air dryer and quantified by filtering. The exhaust filter clogging in the first section was measured by a time required for the exhaust air volume to be reduced to approximately 50% while monitoring the exhaust air volume. The results are illustrated in Table 1.

### Example 2

In Example 2, a die 30 similar to the die 30 in Example 1 was used except that the ratio E2/E1 of the second end space 35 to the first end space 34 was 1.26 and the number of nozzles 31 was 24 as conditions of the die 30. The results are illustrated in Table 1.

### Example 3

In Example 3, a die 30 similar to the die 30 in Example 1 was used except that the ratio E2/E1 of the second end space 35 to the first end space 34 was 1.18 and the number of nozzles 31 was 24 as conditions of the die 30. The results are illustrated in Table 1.

### Example 4

In Example 4, a die 30 similar to the die 30 in Example 1 was used except that the ratio E2/E1 of the second end space 35 to the first end space 34 was 1.19, the number of nozzles 31 was 12, and the second end space 35 was rounded as conditions of the die 30. The results are illustrated in Table 1.

### Example 5

In Example 5, a die 30 similar to the die 30 in Example 4 was used except that the number of nozzles 31 was 24 as a condition of the die 30. The results are illustrated in Table 1.

### Example 6

In Example 6, a die 30 similar to the die 30 in Example 4 was used except that the number of nozzles 31 was 34 as a condition of the die 30. The results are illustrated in Table 1.

### Example 7

In Example 7, a die 30 similar to the die 30 in Example 5 was used except that a cutter RPM (revolutions per minute) was 1200 rpm, and the boundary space of the first end space 34 with the base space 32 was rounded as conditions of the die 30.

The results are illustrated in Table 2.

### Example 8

In Example 8, a die 30 similar to the die 30 in Example 7 was used except that a cutter RPM was 400 rpm. The results are illustrated in Table 2.

### Example 9

In Example 9, a die 30 similar to the die 30 in Example 7 was used except that a cutter RPM was 800 rpm. The results are illustrated in Table 2.

### Example 10

In Example 10, a die 30 similar to the die 30 in Example 9 was used except that the charge rate was 700 kg/h, and the above-described grooves were formed on the liner 50.

The results are illustrated in Table 2.

### Example 11

In Example 11, a die 30 similar to the die 30 in Example 10 was used except that the above-described screw 60 was used. The results are illustrated in Table 2.

### Example 12

In Example 12, a die 30 similar to the die 30 in Example 2 was used except that the shape of the nozzle 31 was an array form, and the number of nozzles 31 was 48 as conditions of the die 30.

The results are illustrated in Table 2.

### Example 13

In Example 13, a die 30 similar to the die 30 in Example 12 was used except that the second end space 35 was rounded as a condition of the die 30.

The results are illustrated in Table 3.

### Example 14

In Example 14, a die 30 similar to the die 30 in Example 13 was used except that the boundary space of the first end space 34 with the base space 32 was rounded, a belt conveyor was used for the conveyor, and the charge rate was 4000 kg/h as conditions of the die 30.

The results are illustrated in Table 3.

### Comparative Example 1

A die similar to the die 30 in Example 1 was used except that the ratio of the second end space 35 to the first end space 34 was 1, and the number of nozzles of the die was 48. The results are illustrated in Table 3.

### Comparative Example 2

A die similar to the die in Comparative Example 1 was used except that the number of nozzles of the die was 42. The results are illustrated in Table 3.

### Comparative Example 3

A die similar to the die in Comparative Example 1 was used except that the number of nozzles of the die was 60. The results are illustrated in Table 3.

### Comparative Example 4

A die similar to the die in Example 1 was used except that the shape of a nozzle of the die was a star shape, and the number of nozzles of the die was 74. The results are illustrated in Table 3.

TABLE 1

| | EXAMPLE | EXAMPLE | EXAMPLE | EXAMPLE | EXAMPLE | EXAMPLE |
|---|---|---|---|---|---|---|
| | 1 | 2 | 3 | 4 | 5 | 6 |
| DIE NOZZLE SHAPE | CROSS | CROSS | CROSS | CROSS | CROSS | CROSS |
| | TYPE | TYPE | TYPE | TYPE | TYPE | TYPE |
| PERIMETER L | 39.76 | 44.24 | 43.82 | 43.57 | 43.57 | 43.57 |
| [mm] | | | | | | |
| OPENING AREA S | 25.21 | 34.25 | 35.12 | 35.50 | 35.50 | 35.50 |
| [mm²] | | | | | | |
| SHAPE FACTOR L/S | 1.58 | 1.29 | 1.25 | 1.23 | 1.23 | 1.23 |
| [mm⁻¹] | | | | | | |
| FIRST END SPACE | 1.10 | 1.55 | 1.65 | 1.65 | 1.65 | 1.65 |
| E1 | | | | | | |
| SECOND END SPACE | 1.90 | 1.95 | 1.95 | 1.96 | 1.96 | 1.96 |
| E2 | | | | | | |
| E2/E1 | 1.73 | 1.26 | 1.18 | 1.19 | 1.19 | 1.19 |
| NUMBER OF | 34 | 24 | 24 | 12 | 24 | 34 |
| DIE NOZZLES | | | | | | |
| OPENING AREA | 857 | 822 | 843 | 426 | 852 | 1207 |
| [mm²] | | | | | | |
| ROUND PROCESS | ABSENT | ABSENT | ABSENT | END | END | END |
| CONVEYOR | VIBRATION | VIBRATION | VIBRATION | VIBRATION | VIBRATION | VIBRATION |
| CUTTER | PRESENT | PRESENT | PRESENT | PRESENT | PRESENT | PRESENT |
| NUMBER OF | 800 | 800 | 800 | 800 | 800 | 800 |
| ROTATIONS [rpm] | | | | | | |
| EXTRUSION | 14A | 14A | 14A | 14A | 14A | 14A |
| DRYER SIZE | | | | | | |
| RATE [kg/h] | 5500 | 5500 | 5500 | 5500 | 5500 | 5500 |
| DIE FLOW RATE | 6.4 | 6.7 | 6.5 | 12.9 | 6.5 | 4.6 |
| [kg/h/mm²] | | | | | | |
| EXTRUSION DRYER | | | | | | |
| ADDITIONAL CONDITION | | | | | | |
| HOT AIR | 100 | 100 | 100 | 100 | 100 | 100 |
| TEMPERATURE 1 [° C.] | | | | | | |
| HOT AIR | 90 | 90 | 90 | 90 | 90 | 90 |
| TEMPERATURE 2 [° C.] | | | | | | |
| RESIDENCE TIME | 4.5 | 4.5 | 4.5 | 4.5 | 4.5 | 4.5 |
| [MINUTES] | | | | | | |
| FILTER CLOGGING | 3 | 10 | 16 | 24< | 24< | 24< |
| TIME [h] | | | | | | |
| AMOUNT OF FINE | 9.3 | 5.8 | 5.3 | 6.1 | 4.7 | 3.8 |
| POWDER [wt %] | | | | | | |
| HEATING LOSS [wt %] | 0.7 | 0.62 | 0.55 | 0.52 | 0.45 | 0.4 |
| MICROGEL | 0.5 | 0.1 OR | 0.1 OR | 0.1 OR | 0.1 OR | 0.1 OR |
| [mm] | | LESS | LESS | LESS | LESS | LESS |
| DRYING UNIFORMITY | 13 | 7 | 8 | 3 | 5 | 5 |
| [NUMBER OF BALES IN 100 BALES] | | | | | | |

TABLE 2

| | EXAMPLE | EXAMPLE | EXAMPLE | EXAMPLE | EXAMPLE | EXAMPLE |
|---|---|---|---|---|---|---|
| | 7 | 8 | 9 | 10 | 11 | 12 |
| DIE NOZZLE SHAPE | CROSS | CROSS | CROSS | CROSS | CROSS | ARRAY |
| | TYPE | TYPE | TYPE | TYPE | TYPE | TYPE |
| PERIMETER L | 43.23 | 43.23 | 43.23 | 43.23 | 43.23 | 25.01 |
| [mm] | | | | | | |
| OPENING AREA S | 35.54 | 35.54 | 35.54 | 35.54 | 35.54 | 17.87 |
| [mm²] | | | | | | |
| SHAPE FACTOR L/S | 1.22 | 1.22 | 1.22 | 1.22 | 1.22 | 1.40 |
| [mm⁻¹] | | | | | | |
| FIRST END SPACE | 1.65 | 1.65 | 1.65 | 1.65 | 1.65 | 1.55 |
| E1 | | | | | | |
| SECOND END SPACE | 1.96 | 1.96 | 1.96 | 1.96 | 1.96 | 1.85 |
| E2 | | | | | | |
| E2/E1 | 1.19 | 1.19 | 1.19 | 1.19 | 1.19 | 1.26 |
| NUMBER OF | 24 | 24 | 24 | 24 | 24 | 48 |
| DIE NOZZLES | | | | | | |
| OPENING AREA | 853 | 853 | 853 | 853 | 853 | 858 |
| [mm²] | | | | | | |
| ROUND PROCESS | END + | END + | END + | END + | END + | ABSENT |
| | CENTER | CENTER | CENTER | CENTER | CENTER | |
| CONVEYOR | VIBRATION | VIBRATION | VIBRATION | VIBRATION | VIBRATION | VIBRATION |
| CUTTER | PRESENT | PRESENT | PRESENT | PRESENT | PRESENT | PRESENT |
| NUMBER OF | 1200 | 400 | 800 | 800 | 800 | 800 |
| ROTATIONS [rpm] | | | | | | |
| EXTRUSION | 14A | 14A | 14A | 14A | 14A | 14A |
| DRYER SIZE | | | | | | |
| RATE [kg/h] | 5500 | 5500 | 5500 | 7000 | 7000 | 5500 |
| DIE FLOW RATE | 6.4 | 6.4 | 6.4 | 8.2 | 8.2 | 6.4 |
| [kg/h/mm²] | | | | | | |
| EXTRUSION DRYER | | | | GROOVE | GROOVE + | |
| ADDITIONAL CONDITION | | | | | SCREW | |
| HOT AIR | 100 | 100 | 100 | 100 | 100 | 100 |
| TEMPERATURE 1 [° C.] | | | | | | |
| HOT AIR | 90 | 90 | 90 | 90 | 90 | 90 |
| TEMPERATURE 2 [° C.] | | | | | | |
| RESIDENCE TIME | 4.5 | 4.5 | 4.5 | 4.5 | 4.5 | 4.5 |
| [MINUTES] | | | | | | |
| FILTER CLOGGING | 6 | 24< | 24< | 24< | 24< | 24< |
| TIME [h] | | | | | | |
| AMOUNT OF FINE | 6.2 | 4.1 | 6.0 | 4.2 | 4.2 | 6.3 |
| POWDER [wt %] | | | | | | |
| HEATING LOSS [wt %] | 0.51 | 0.53 | 0.50 | 0.42 | 0.42 | 0.66 |
| MICROGEL | 0.1 OR | 0.1 OR | 0.1 OR | 0.1 OR | 0.1 OR | 0.1 OR |
| [mm] | LESS | LESS | LESS | LESS | LESS | LESS |
| DRYING UNIFORMITY | 3 | 6 | 2 | 1 | 0.5 | 16 |
| [NUMBER OF BALES IN 100 BALES] | | | | | | |

TABLE 3

| | EXAMPLE | EXAMPLE | COMPARATIVE | COMPARATIVE | COMPARATIVE | COMPARATIVE |
|---|---|---|---|---|---|---|
| | 13 | 14 | EXAMPLE 1 | EXAMPLE 2 | EXAMPLE 3 | EXAMPLE 4 |
| DIE NOZZLE SHAPE | ARRAY | CROSS | CROSS | CROSS | CROSS | STAR |
| | TYPE | TYPE | TYPE | TYPE | TYPE | TYPE |
| PERIMETER L | 24.67 | 43.23 | 30.00 | 30.00 | 30.00 | 16.99 |
| [mm] | | | | | | |
| OPENING AREA S | 17.87 | 35.54 | 20.25 | 20.25 | 20.25 | 10.83 |
| [mm²] | | | | | | |
| SHAPE FACTOR L/S | 1.38 | 1.22 | 1.48 | 1.48 | 1.48 | 1.57 |
| [mm⁻¹] | | | | | | |
| FIRST END SPACE | 1.55 | 1.65 | 1.50 | 1.50 | 1.50 | 1.90 |
| E1 | | | | | | |
| SECOND END SPACE | 1.85 | 1.96 | 1.50 | 1.50 | 1.50 | 0.00 |
| E2 | | | | | | |
| E2/E1 | 1.26 | 1.19 | 1.00 | 1.00 | 1.00 | 0.00 |
| NUMBER OF | 48 | 6 | 20 | 42 | 60 | 74 |
| DIE NOZZLES | | | | | | |
| OPENING AREA | 856 | 213 | 405 | 851 | 1215 | 801 |
| [mm²] | | | | | | |
| ROUND PROCESS | END | END + | ABSENT | ABSENT | ABSENT | ABSENT |
| | | CENTER | | | | |
| CONVEYOR | VIBRATION | BELT | VIBRATION | VIBRATION | VIBRATION | VIBRATION |
| CUTTER | PRESENT | ABSENT | PRESENT | PRESENT | PRESENT | PRESENT |
| NUMBER OF | 800 | — | 800 | 800 | 800 | 800 |
| ROTATIONS [rpm] | | | | | | |
| EXTRUSION | 14A | 10A | 14A | 14A | 14A | 14A |
| DRYER SIZE | | | | | | |
| RATE [kg/h] | 5500 | 4000 | 5500 | 5500 | 5500 | 5500 |
| DIE FLOW RATE | 6.4 | 18.8 | 13.6 | 6.5 | 4.5 | 6.9 |
| [kg/h/mm²] | | | | | | |
| EXTRUSION DRYER | | | | | | |
| ADDITIONAL CONDITION | | | | | | |
| HOT AIR | 100 | ABSENT | 100 | 100 | 100 | 100 |
| TEMPERATURE 1 [° C.] | | | | | | |
| HOT AIR | 90 | 90 | 110 | 110 | 110 | 110 |
| TEMPERATURE 2 [° C.] | | | | | | |
| RESIDENCE TIME | 4.5 | 12 | 4.5 | 4.5 | 4.5 | 4.5 |
| [MINUTES] | | | | | | |
| FILTER CLOGGING | 24< | 24< | 1 | 1 | 6 | 3 |
| TIME [h] | | | | | | |
| AMOUNT OF FINE | 5.5 | 5.5 | 20.3 | 14.9 | 13.2 | 15.6 |
| POWDER [wt %] | | | | | | |
| HEATING LOSS [wt %] | 0.63 | 0.54 | 0.92 | 0.75 | 0.68 | 1.10 |
| MICROGEL | 0.1 OR | 0.5 | 1 | 1 | 0.5 | 0.1 OR |
| [mm] | LESS | | | | | LESS |
| DRYING UNIFORMITY | 11 | 11 | 20 | 22 | 32 | 38 |
| [NUMBER OF BALES IN 100 BALES] | | | | | | |

As illustrated in Tables 1 to 3, a rubbery polymer with good evaluations in all evaluation items of the filter clogging time, small amount of powder, heating loss, microgel, and dry uniformity were obtained in a case of using an extrusion dryer having a die 30 with nozzles 31, where each nozzle 31 has at least one extended space 33 communicating with the base space 32, and forms an opening width expanding in a direction away from the base space 32 (Examples 1 to 14). By contrast, as illustrated in Table 3, a rubbery polymer with good evaluations in the evaluation items of the clogging time, small amount of powder, heating loss, microgel, and dry uniformity of the filter was not obtained in a case of using an extrusion dryer with a conventional die (cross-shape or star-shape nozzle) (Comparative Examples 1 to 4).

These results illustrate that the use of an extrusion dryer 100 with the above-described die 30 was enabled to reduce generation of fine powder during extrusion drying of the rubbery polymer, and also perform sufficient drying.

Further, as illustrated in Table 1, a better reduction effect of the fine powder was obtained in a case of using an extrusion dryer 100 with a die 30 having nozzles 31, where each nozzle 31 is provided with an additional arc-shaped extended space 36 at the second end space 35 of the extended space 33. In addition, the reduction effect of fine powder and the effect of drying were maintained even with a faster flow rate of the die (Example 4).

Moreover, as illustrated in Table 2, a good reduction effect of fine powder was obtained even with higher rotation speed of the cutter in a case of using an extrusion dryer 100 with a die 30 having nozzles 31 where each nozzle 31 has no corners at a boundary space of the first end space 34 with the base space 32 (Example 7).

In addition, as illustrated in Table 2, drying uniformity was further improved in a case of using an extrusion dryer 100 with die 30 having nozzles 31, where each nozzle 31 has no corners at the boundary space 37 of the extended spaces 33 with the base space 32, and the above-described grooves are formed in the liner 50 (Example 10).

Further, as illustrated in Table 2, the drying uniformity was further improved in the zone closest to the die 30, in a case of using a screw 60 with the shaft outer diameter in the conveyance section being smaller than the shaft outer diameter in the compression section (Example 11).

The embodiments of the present invention have been described above; however, these embodiments are not limited to specific embodiments and examples, but various modifications and changes are possible within the scope of the invention as claimed in the appended claims.

The present international application is based on and claims priority to Japanese Patent Application No. 2017-61936, filed on Mar. 27, 2017, the entire contents of which are hereby incorporated by reference.

### DESCRIPTION OF THE REFERENCE NUMERALS

100 extrusion dryer
20 cylinder
21 first zone
21A first conveyance section
21B first compression section
22 second zone
22A second conveyance section
22B second compression section
30 die
31 nozzle
32 base space
33 extended space
34 first end space
35 second end space
36 additional extension space
37 boundary space
40 actuator
50 liner
51,52 groove
60 screw
61 shaft
62 flight

1. A rubbery polymer extrusion dryer comprising:
a cylinder; and
a die having a plurality of openings at one end of the cylinder, wherein
each of the openings includes an opening base and at least one extended opening portion in communication with the opening base, and
the extended opening portion has a shape with an opening width expanding in a direction away from the opening base.

2. The rubbery polymer extrusion dryer according to claim 1, wherein
the extended opening portion has a first opening end portion in communication with the opening base and a second opening end portion away from the opening base, and
a ratio of an opening width at the second opening end portion to an opening width at the first opening end portion is greater than 1.

3. The rubbery polymer extrusion dryer according to claim 2, wherein
the second opening end portion is in communication with an additional arc-shaped extended opening portion.

4. The rubbery polymer extrusion dryer according to claim 1, wherein
each of the openings has a shape with no corner at a boundary space at which the extended opening portions are connected with the opening base.

5. The rubbery polymer extrusion dryer according to claim 1, wherein
the at least one extended opening portion includes four extended opening portions, and
the each of the openings has a cross shape.

6. The rubbery polymer extrusion dryer according to claim 1, wherein
the at least one extended opening portion includes two extended opening portions, and
the each of the openings is of an array form.

7. The rubbery polymer extrusion dryer according to claim 1, further comprising:
a liner provided on an inner peripheral surface of the cylinder, wherein
the liner includes a plurality of grooves formed on an inner surface of the liner.

8. The rubbery polymer extrusion dryer according to claim 1, further comprising:
a screw rotatably disposed within the cylinder, the screw having a shaft and helical flights formed on an outer peripheral surface of the shaft, wherein
the screw includes a plurality of zones each having a conveyance section and a compression section, and
in a zone closest to the die, an outer diameter of the shaft at the conveyance section is smaller than an outer diameter of the shaft at the compression section.

9. A method of drying a rubbery polymer, the method comprising:
drying a rubbery polymer using an extrusion dryer, the extrusion dryer including
a cylinder, and
a die having a plurality of openings at one end of the cylinder, wherein
each of the openings includes an opening base and at least one extended opening portion in communication with the opening base, and
the extended opening portion has a shape with an opening width expanding in a direction away from the opening base.

10. A method of producing a rubbery polymer, the method comprising:
preparing a slurry of a rubbery polymer by coagulating a solution of a rubbery polymer;
dehydrating the slurry; and
drying the dehydrated rubbery polymer by extrusion, the drying of the dehydrated rubbery polymer being performed using an extrusion dryer, wherein
the extrusion dryer includes a cylinder, and a die having a plurality of openings at one end of the cylinder, and wherein
each of the openings includes an opening base and at least one extended opening portion in communication with the opening base, and the extended opening portion has a shape with an opening width expanding in a direction away from the opening base.
